(19) United States
(12) Patent Application Publication
(10) Pub. No.: US 2011/0090506 A1
(43) Pub. Date: Apr. 21, 2011

(54) Self-referencing fiber-optic localized plasmon resonance sensing device and system thereof

(75) Inventors: LA-KWAN CHAU, CHIAYI CITY (TW); CHANG-YUE CHIANG, TAIPING CITY (TW)

(73) Assignee: NATIONAL CHUNG CHENG UNIVERSITY, CHIA-YI (TW)

(21) Appl. No.: 12/806,315

(22) Filed: Aug. 10, 2010

(30) Foreign Application Priority Data
Oct. 20, 2009 (TW) 098135503

(51) Int. Cl. G01N 21/55

(52) U.S. Cl. 356/445

(57) ABSTRACT

The present invention discloses a self-referencing fiber-optic localized plasmon resonance sensing device and a system thereof. The self-referencing fiber-optic localized plasmon resonance sensing device comprises a reference optical fiber, a sensing optical fiber and a carrier. The reference optical fiber is modified with a first noble metal nanoparticle layer, and receives an incident light to generate a first localized plasmon resonance sensor signal. The sensing optical fiber is modified with a second noble metal nanoparticle layer. The second noble metal nanoparticle layer is further modified with a molecular or biological recognition unit, and receives the incident light to generate a second localized plasmon resonance sensor signal. The carrier is used for placement of the reference optical fiber and the sensing optical fiber. A processing unit is allowed to perform referencing on the second localized plasmon resonance sensor signal based on the first localized plasmon resonance sensor signal.

### BACKGROUND OF THE INVENTION

1. Field of the Invention

The present invention relates to a fiber-optic localized plasmon resonance sensing device and a system thereof; in particular, it relates to a self-referencing fiber-optic localized plasmon resonance sensing device and a system thereof.

2. Description of Related Art

The electron cloud on the surface of metal nanoparticles can be excited by an electromagnetic field of a specific frequency, which is resonant with the collective oscillation of the conduction electrons confined within the volume of the nanoparticles, accordingly also known as the Localized Plasmon Resonance (LPR), as shown in FIG. 1. The noble metal nanoparticle 1 generates an intense absorption band in the absorption spectrum, which is referred as the localized plasmon resonance band. The fundamental principle of the localized plasmon resonance sensing system is that, upon conjugation of a recognition unit on the surface of noble metal nanoparticle 1 and a target binds with the recognition unit, the target accordingly covers the vicinity of the surface on the noble metal nanoparticle 1, such that a change occurs in the surrounding dielectric environment at which the noble metal nanoparticle 1 is located and whose peak wavelength position and absorption are extremely sensitive to variation in the dielectric constant of the exterior surrounding, thus leading to alternation in the LPR resonance band; and finally by means of modifying the recognition unit for enabling specific detection capability, then through analysis on the relationship between the variation in the frequency or absorption of the resonance band and the concentration of the target, it is possible to establish a quantitative detection method. The method basically comprises modifying the noble metal nanoparticles on an optical fiber, thereby forming a noble metal nanoparticle layer thereon. The said noble metal nanoparticle layer is made by one of the sphere-shaped noble metal nanoparticle, the cube-shaped noble metal nanoparticle, the prism-shaped noble metal nanoparticle, the rod-shaped noble metal nanoparticle and the shell-shaped noble metal nanoparticle, with essentially no connections existing between the nanoparticles, and the noble metal may be gold, silver or platinum. By using the effect of multiple total internal reflections along an optical waveguide, it is possible to accumulate the amount of change in the absorption of the evanescent wave due to absorption by the nanoparticle plasmon resonance so as to enhance the LPR signal for sensing operations. Meanwhile, through modification of the surface of the noble metal nanoparticle 1 with various recognition units, the functionalized noble metal nanoparticles can be applied to detection of various targets.

The single fiber-optic LPR sensing system lacks the ability to compensate influences caused by instrumental or environmental factors, such as baseline drift due to instability of the light source, and changes in the temperature or the composition of the solution to be tested, since the LPR sensing technology employs the sensitivity of the noble metal nanoparticle to the refractive index in the surrounding environment as a way to detect biological molecules, which is also dependent on the temperature or the composition of the samples. During detection of real samples, it is commonly required to control the temperature of the sample or undergo dilution more than two times in the sample preparation processes. An addition of temperature control system may increase system complexity while multiple dilutions may undesirably degrade the effective detection limit.

### SUMMARY OF THE INVENTION

Regarding to the aforementioned drawbacks in prior art, the objective of the present invention is to provide a self-referencing fiber-optic localized plasmon resonance sensing device and system in order to eliminate the interferences induced by environmental factors or dielectric properties inherent in the sample itself, and also resolve the issue of nonspecific adsorption.

According to an objective of the present invention, a self-referencing fiber-optic localized plasmon resonance sensing device is herein provided, comprising: a reference optical fiber, a sensing optical fiber and a carrier. The reference optical fiber is modified with a first noble metal nanoparticle layer, and receives an incident light to generate a first localized plasmon resonance sensor signal. The sensing optical fiber is modified with a second noble metal nanoparticle layer, which second noble metal nanoparticle layer being further modified with a molecular or biological recognition unit, and receives the incident light to generate a second localized plasmon resonance sensor signal. The carrier is used for placement of the reference optical fiber and the sensing optical fiber. A processing unit is allowed to perform referencing on the second localized plasmon resonance sensor signal based on the first localized plasmon resonance sensor signal.

The first localized plasmon resonance sensor signal can be the signal I_{R0}, which is obtained upon detecting on a blank and with the nanoparticle surface of the reference optical fiber not modified with a recognition unit, and the signal I_{R}, which is obtained upon detecting a sample of a certain concentration of a target by means the reference optical fiber; the second localized plasmon resonance sensor signal can be the signal I_{S0}, which is obtained upon detecting on the blank and with the nanoparticle surface of the sensing optical fiber modified with a recognition unit, and the signal I_{S}, which is obtained upon detecting the sample by means the sensing optical fiber. The first localized plasmon resonance sensor signal and the second localized plasmon resonance sensor signal can be expressed by the following equations:

I′₀=I_{S0}/I_{R0};

I′=I_{S}/I_{R};

T′=I′/I′₀=(I_{S}/I_{R})/(I_{S0}/I_{R0})=(I_{S}/I_{S0})/(I_{R}/I_{R0})=T_{S}/T_{R};

I′₀ indicates the corrected signal obtained by the division of the above-said I_{S0} by I_{R0} when detecting the same blank; I′ is the corrected signal obtained by the division of the above-said I_{S} by I_{R} when detecting the same sample; and T′=I′/I′₀ represents the relative signal obtained after self-referencing.

The first noble metal nanoparticle layer is immobilized at an unclad portion or an end face of the reference optical fiber.

The second noble metal nanoparticle layer is immobilized at an unclad portion or an end face of the sensing optical fiber.

The fiber-optic localized plasmon resonance sensing device is a micro fluidic chip or an in-situ sampling and analysis device. In case that the fiber-optic localized plasmon resonance sensing device is a an in-situ sampling and analysis device, the reference optical fiber and the sensing optical fiber may be constructed with a mirror at one end face of the optical fibers, or further installed with a filter membrane and a rigid holder with at least one opening, in which the mirror is used to reflect the first localized plasmon resonance sensor signal and the second localized plasmon resonance sensor signal, the filter membrane sieves out interfering substances with of sizes larger than that of the average pore size of the membrane, and the rigid holder may encase the reference optical fiber and the sensing optical fiber in order to enhance the mechanical strength of the device during the sampling operation.

The referencing indicated as above may include compensations for interferences caused by the refractive index variation in the solution to be tested due to fluctuation in ambient temperature or composition variation of the sample, spectral interference due to the color of the solution, undesirable vibration, or signal deviation resulted from unstable light source.

The recognition unit indicated as above may comprise a chemical recognition molecule, an antibody, an antigen, a lectin, a hormone receptor, a nucleic acid or a carbohydrate.

According to another objective of the present invention, a self-referencing fiber-optic localized plasmon resonance sensing system is herein provided, comprising: a light source, a fiber-optic localized plasmon resonance sensing device and a photo detecting unit. The fiber-optic localized plasmon resonance sensing device comprises a reference optical fiber, a sensing optical fiber and a carrier. The light source generates an incident light. The reference optical fiber-optic is modified with a first noble metal nanoparticle layer, and receives the incident light to generate a first localized plasmon resonance sensor signal. The sensing optical fiber is modified with a second noble metal nanoparticle layer, which second noble metal nanoparticle layer being further modified with a molecular or biological recognition unit, and receives the incident light to generate a second localized plasmon resonance sensor signal. The carrier is used for placement of the reference optical fiber and the sensing optical fiber. The photo detecting unit receives the first localized plasmon resonance sensor signal and the second localized plasmon resonance sensor signal. A processing unit is allowed to perform referencing on the second localized plasmon resonance sensor signal based on the first localized plasmon resonance sensor signal.

The first localized plasmon resonance sensor signal can be the signal I_{R0}, which is obtained upon detecting a blank and with the nanoparticle surface of the reference optical fiber not modified with a recognition unit, and the signal I_{R}, which is obtained upon detecting a sample of a certain concentration of a target by means of the reference optical fiber; the second localized plasmon resonance sensor signal can be the signal I_{S0}, which is obtained upon detecting on the blank and with the nanoparticle surface of the sensing optical fiber modified with the recognition unit, and the signal I_{S}, which is obtained upon detecting the sample by means of the sensing optical fiber. The first localized plasmon resonance sensor signal and the second localized plasmon resonance sensor signal can be expressed by the following equations:

I′₀=I_{S0}/I_{R0};

I′=I_{S}/I_{R};

T′=I′/I′₀=(I_{S}/I_{R})/(I_{S0}/I_{R0})=(I_{S}/I_{S0})/(I_{R}/I_{R0})=T_{S}/T_{R};

I′₀ indicates the corrected signal obtained by the division of the above-said I_{S0} by I_{R0} when detecting the blank; I′ is the corrected signal obtained by the division of the above-said I_{S} by I_{R} when detecting the sample having the same concentration of the target; and T′=I′/I′₀ represents the relative signal obtained after self-referencing.

The first noble metal nanoparticle layer is modified at an unclad portion or an end face of the reference optical fiber.

The second noble metal nanoparticle layer is modified at an unclad portion or an end face of the sensing optical fiber.

The fiber-optic localized plasmon resonance sensing device is a micro fluidic chip or an in-situ sampling and analysis device. In case that the fiber-optic localized plasmon resonance sensing device is an in-situ sampling and analysis device, the reference optical fiber and the sensing optical fiber may be constructed with a mirror at one end face of the optical fibers, or further installed with a filter membrane and a rigid holder with at least one opening, in which the mirror is used to reflect the first localized plasmon resonance sensor signal and the second localized plasmon resonance sensor signal, the filter membrane sieves out interfering substances of sizes larger than that of the average pore size of the membrane, and the rigid holder may encase the reference optical fiber and the sensing optical fiber in order to enhance the mechanical strength of the device during the sampling operation.

The referencing indicated as above may include compensations for interferences caused by the refractive index variation in the solution to be tested due to fluctuation in ambient temperature or composition variation of the sample, spectral interference due to the color of the solution, undesirable vibration, or signal deviation resulted from unstable light source.

The recognition unit indicated as above may comprise a chemical recognition molecule, an antibody, an antigen, a lectin, a hormone receptor, a nucleic acid or a carbohydrate.

It may further comprise a signal generator for driving the light source to generate and regulate the incident light, and also further comprise a lock-in amplifier enabling amplification of the first localized plasmon resonance sensor signal and the second localized plasmon resonance sensor signal as well as suppression of system noises.

In summary of the descriptions set forth hereinbefore, the self-referencing fiber-optic localized plasmon resonance sensing device and a system thereof according to the present invention allows one or more of the following advantages:

(1) the disclosed self-referencing fiber-optic localized plasmon resonance sensing device and a system thereof are able to reduce interferences caused by environmental factors or dielectric properties inherent in the sample itself, and also resolve the issue of nonspecific adsorption, allowing the sensing system to provide the self-referencing feature thereby improving the detection performance of the fiber-optic localized plasmon resonance sensing device and system on real samples;

(2) the disclosed self-referencing fiber-optic localized plasmon resonance sensing device and a system thereof allows, during detection of targets, to lessen the number of dilutions for the samples in the sample preparation processes, thereby improving the detection limit for sensing operations.

### BRIEF DESCRIPTION OF THE DRAWINGS

FIG. 1 is a diagram for the localized plasmon resonance in prior art;

FIG. 2 is a diagram for a self-referencing fiber-optic localized plasmon resonance sensing device according to the present invention;

FIG. 3a is a diagram for an optical fiber according to the present invention whose cladding layer at a certain region of the fiber is stripped entirely;

FIG. 3b is a diagram for an optical fiber according to the present invention whose cladding layer at a certain region of the fiber is partially stripped;

FIGS. 3c and 3d are cross-sectional views for an optical fiber according to the present invention whose cladding layer at a certain region of the fiber is partially stripped;

FIG. 3e is a diagram for a reference optical fiber according to the present invention whose noble metal nanoparticle surface is modified with a monolayer having a thiol head group and a hydroxyl end group;

FIG. 3f is a diagram for a sensing optical fiber according to the present invention whose noble metal nanoparticle surface is modified with a mixed monolayer having a thiol head group and a hydroxyl or a carboxylic acid end group;

FIG. 3g is a diagram for a sensing optical fiber-optic according to the present invention whose noble metal nanoparticle surface is modified with a monolayer having a thiol head group and an amino end group;

FIG. 4a is a diagram for a first embodiment of the self-referencing fiber-optic localized plasmon resonance sensing device according to the present invention;

FIG. 4b is a diagram for a second embodiment of the self-referencing fiber-optic localized plasmon resonance sensing device according to the present invention;

FIG. 4c is a diagram for a third embodiment of the self-referencing fiber-optic localized plasmon resonance sensing device according to the present invention;

FIG. 5 is a diagram for a second embodiment of the self-referencing fiber-optic localized plasmon resonance sensing device according to the present invention;

FIG. 6a is a diagram for a third embodiment of the self-referencing fiber-optic localized plasmon resonance sensing device according to the present invention;

FIG. 6b is a diagram for a reference optical fiber and a sensing optical fiber according to the present invention whose end face is respectively modified with a noble metal nanoparticle layer;

FIG. 7 is a diagram for a self-referencing fiber-optic localized plasmon resonance sensing system according to the present invention;

FIG. 8a is a diagram for the signal-time relationships obtained by a first embodiment of the self-referencing fiber-optic localized plasmon resonance system according to the present invention;

FIG. 8b is a diagram for the relative signal-time relationship obtained by the first embodiment of the self-referencing fiber-optic localized plasmon resonance system according to the present invention;

FIG. 9a is a diagram for the signal-time relationships obtained by a second embodiment of the self-referencing fiber-optic localized plasmon resonance system according to the present invention;

FIG. 9b is a diagram for the plot of relative signal versus logarithm concentration obtained by the second embodiment of the self-referencing fiber-optic localized plasmon resonance system according to the present invention;

FIG. 10a is a diagram for the signal-time relationships obtained by a third embodiment of the self-referencing fiber-optic localized plasmon resonance system according to the present invention;

FIG. 10b is a diagram for the relative signal-time relationship obtained by the third embodiment of the self-referencing fiber-optic localized plasmon resonance system according to the present invention;

FIG. 11a is a diagram for the signal-time relationships obtained by a fourth embodiment of the self-referencing fiber-optic localized plasmon resonance system according to the present invention;

FIG. 11b is a diagram for the relative signal-time relationship obtained by the fourth embodiment of the self-referencing fiber-optic localized plasmon resonance system according to the present invention;

FIG. 12a is a diagram for the signal-time relationships obtained by a fifth embodiment of the self-referencing fiber-optic localized plasmon resonance system according to the present invention;

FIG. 12b is a diagram for the relative signal-time relationship obtained by the fifth embodiment of the self-referencing fiber-optic localized plasmon resonance system according to the present invention; and

FIG. 12c is a diagram for the plot of relative signal versus logarithm concentration obtained by the fifth embodiment of the self-referencing fiber-optic localized plasmon resonance system according to the present invention.

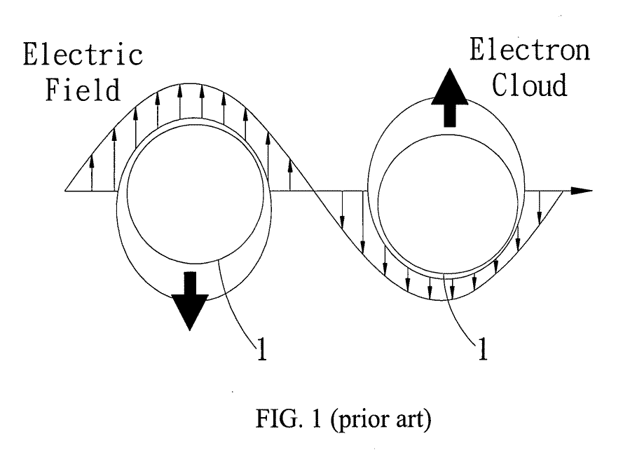

### DETAILED DESCRIPTION OF THE PREFERRED EMBODIMENTS

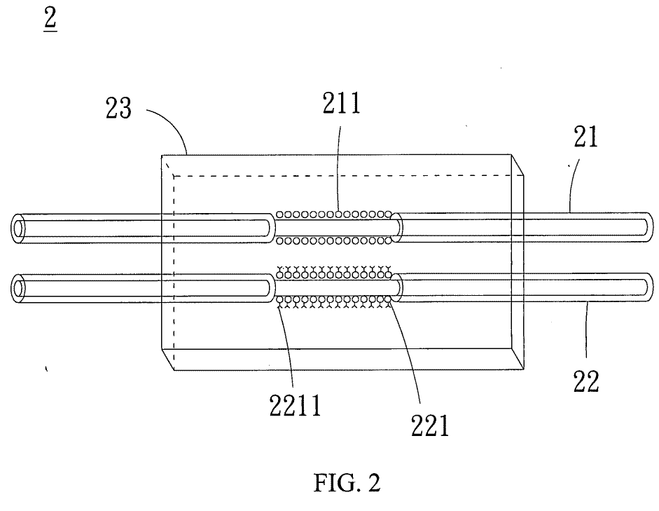

Refer now to FIG. 2, wherein a diagram for a self-referencing fiber-optic localized plasmon resonance sensing device according to the present invention is shown. In the Figure, the self-referencing fiber-optic localized plasmon resonance sensing device 2 comprises a reference optical fiber 21, a sensing optical fiber 22 and a carrier 23. The reference optical fiber 21 is modified with a first noble metal nanoparticle layer 211 and receives an incident light to generate a first localized plasmon resonance sensor signal. The sensing optical fiber 22 is modified with a second noble metal nanoparticle layer 221. The second noble metal nanoparticle layer 221 is further modified with a recognition unit 2211, and receives the incident light to generate a second localized plasmon resonance sensor signal. The carrier 23 is used for placement of the reference optical fiber 21 and the sensing optical fiber 22, wherein a processing unit is allowed to perform referencing on the second localized plasmon resonance sensor signal based on the first localized plasmon resonance sensor signal. The recognition unit may be a chemical recognition molecule, an antibody, an antigen, a lectin, a hormone receptor, a nucleic acid or a carbohydrate.

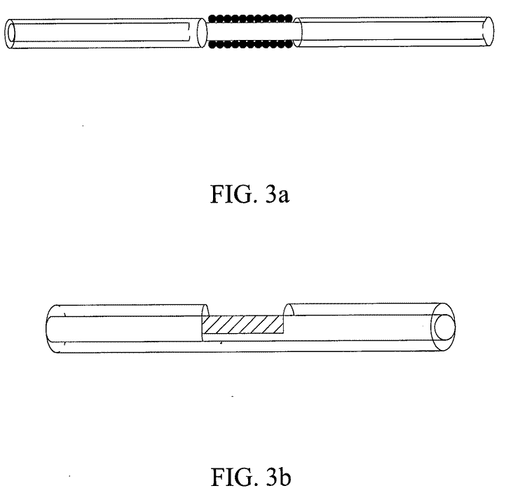

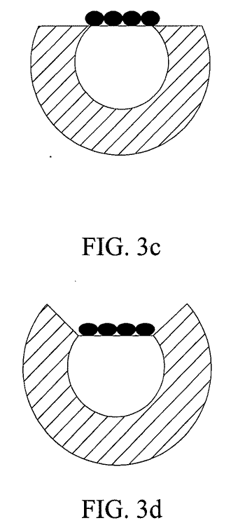

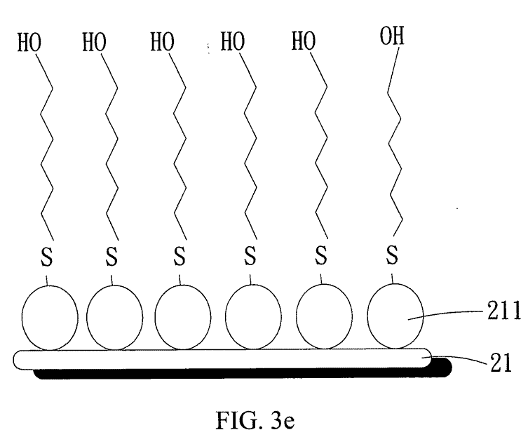

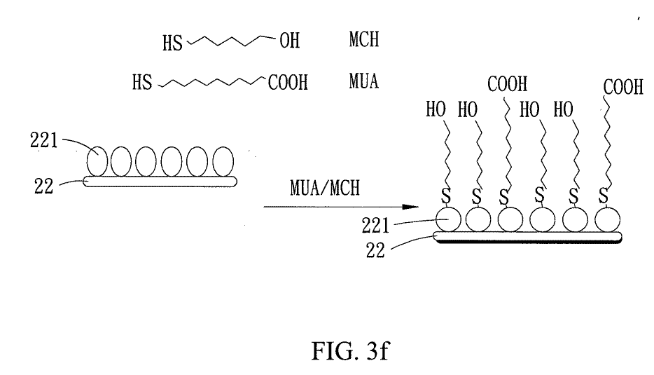

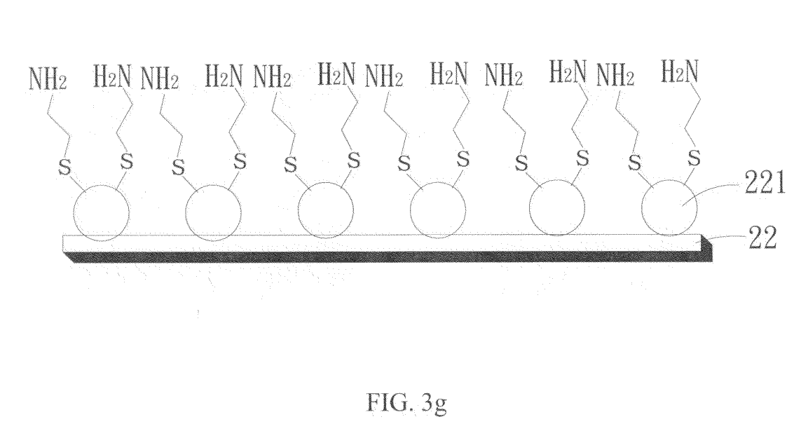

In terms of the reference optical fiber 21 or the sensing optical fiber 22, it is possible to select a region of the optical fiber with the cladding layer thereof entirely stripped, as shown in FIG. 3a, or alternatively a region of the optical fiber with the cladding layer thereof partially stripped, as shown in FIG. 3b. The cross-sectional views for the optical fiber with the cladding layer of a selected region thereof partially stripped are shown in FIGS. 3c and 3d. After removal of the cladding layer, the reference optical fiber 21 can be modified with a first noble metal nanoparticle layer 211 and allowed to be further modified with molecules having a hydroxyl end group (—OH) on the surface of the noble metal nanoparticles so as to provide the surface of the first noble metal nanoparticle layer 211 with hydrophility thereby reducing nonspecific surface adsorption, as shown in FIG. 3e. In order to functionalize molecules with a hydroxyl end group onto the surface of the noble metal nanoparticles, a mercaptohexanol (MCH) solution can be prepared and the reference optical fiber 21 that has the first noble metal nanoparticle layer 211 can be immersed in such the MCH solution for reaction.

After removal of the cladding layer, the sensing optical fiber 22 is also modified with the second noble metal nanoparticle layer 221 and further modified with a specific recognition unit 2211 on the surface of the noble metal nanoparticle, allowing the sensing optical fiber 22 to have a specific detection capability; for example, the surface of the noble metal nanoparticles may be functionalized with long-chain mercaptan molecules containing a carboxylic acid end group (—COOH) or an amino end group (—NH). In order to have the surface of the noble metal nanoparticle to be functionalized with long-chain mercaptan molecules containing a carboxylic acid end group (—COOH) and reduce the nonspecific surface adsorption, a solution consisting of both 11-mercaptoundecanoic acid (MUA) and mercaptohexanol (MCH) at a 1:4 volume ratio can be used for the self-assembly reaction, as shown in FIG. 3f. By adding in short carbon chain MCH molecules at a particular ratio, it is possible to spatially disperse the distance between individual probe molecule, resolving steric hindrance in antibody-antigen recognition thereby improving recognition efficiency thereof. Alternatively, in order to have the surface of the noble metal nanoparticles to be functionalized with mercaptan molecules containing an amino end group as shown in FIG. 3g, it can be performed to prepare a cystamine solution and immerse the sensing optical fiber 22 which has been modified with the second noble metal nanoparticle layer 221 therein for reaction.

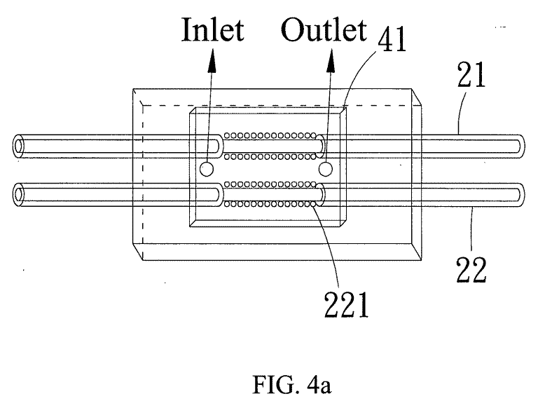

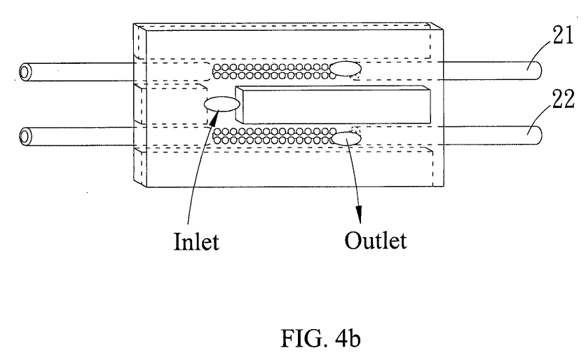

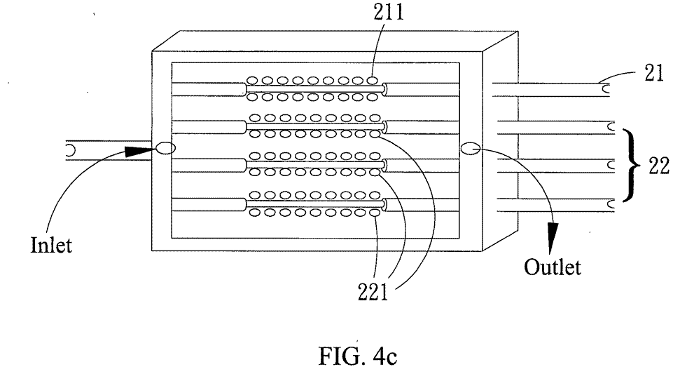

Refer now to FIG. 4, wherein a diagram for a first embodiment of the self-referencing fiber-optic localized plasmon resonance sensing device according to the present invention is shown. In case the fiber-optic localized plasmon resonance device 2 is a micro fluidic chip, the channel portion thereof can be designed as demand in accordance with the target, in which factors needed to be considered may include fluid dynamics upon introduction of the sample, surface tension, fluid volume, internal pressure and residue of sample after analysis. Furthermore, both internal and external factors during chip packaging may be also essential for considerations. Refer to FIG. 4a, wherein a diagram illustrating a basic micro fluidic chip is shown. In this micro fluidic chip, a single sample reservoir 41 is appropriately designed for placement of the reference optical fiber 21, the sensing optical fiber 22 and the sample whose volume may be roughly smaller than or equal to 50 microlitres. Refer next to FIG. 4b, wherein a diagram for an alternative micro fluidic chip according to the present invention is shown. In the Figure, the sample flows to two micro fluidic channels and its volume is approximately smaller than or equal to 40 microlitres. Refer also to FIG. 4c, wherein a diagram for a micro fluidic chip for multiplex detection is shown, wherein it is allowed to place simultaneously a reference optical fiber-optic 21 and plural sensing optical fibers 22 having different recognition units for multiplex sensing operations. The sample volume required for testing is approximately 20-80 microlitres, thereby meeting the requirement of micro analysis for reducing sample consumption and further providing the capability of simultaneous detection of multiple targets for the purpose of time-saving.

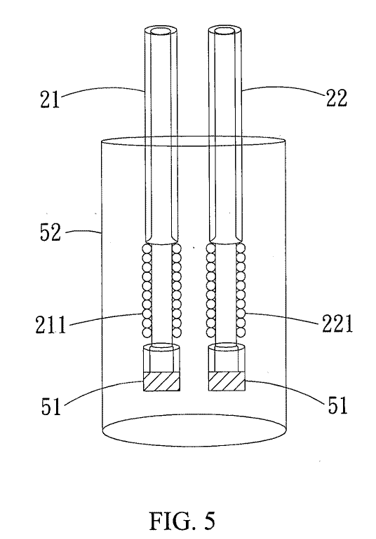

Refer subsequently to FIG. 5, wherein a diagram for a second embodiment of the self-referencing fiber-optic localized plasmon resonance device according to the present invention is shown. In case the fiber-optic localized plasmon resonance device 2 is used in a micro sample tray, the reference optical fiber and the sensing optical fiber may be constructed with a mirror 51 at the distal end face of the optical fiber so as to reflect the first localized plasmon resonance sensor signal and the second localized plasmon resonance sensor signal. A filter membrane 52 may be further installed for blocking interfering substances with sizes larger than that of the average pore size of the membrane out of the filter membrane 52.

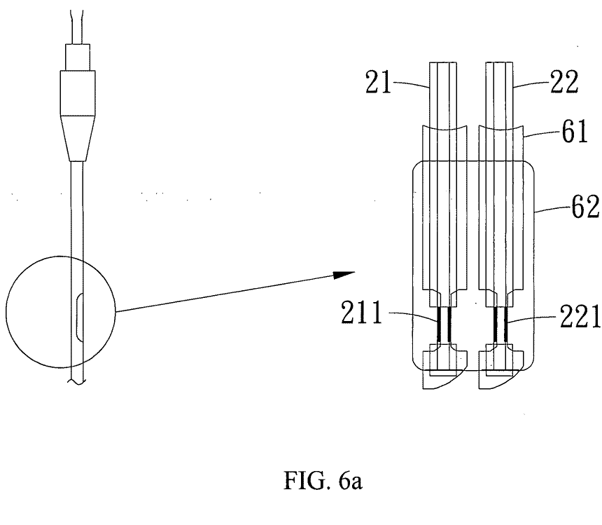

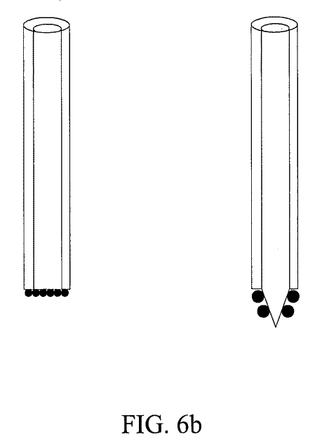

Refer next to FIG. 6a, wherein a diagram for a third embodiment of the self-referencing fiber-optic localized plasmon resonance sensing device according to the present invention is shown. During detection of a real environmental or biological sample or specimen, it is possible to accomplish the in-situ detection by immersion or piercing of the sampling device into a specific sample or object. As a result, the sensing device is suitable for use as an apparatus for medical in-vivo examination or on-site sampling and analysis. During detection of a real sample, there may be various interfering substances existing in the sample, so it is possible to add a filter membrane 62 onto the exterior of the reference optical fiber 21 and the sensing optical fiber 22 so as to isolate interfering substances with sizes larger than that of the average pore size of the membrane out of such filter membrane 62; besides, a rigid holder 61 with a hole configured on the holder thereof may be placed to enhance the physical strength of the entire sensor. Furthermore, it is also possible to modify a noble metal nanoparticle layer 211, 221 respectively on the end face of the reference optical fiber 21 and the sensing optical fiber 22 to facilitate in-situ sampling and analysis, as shown in FIG. 6b.

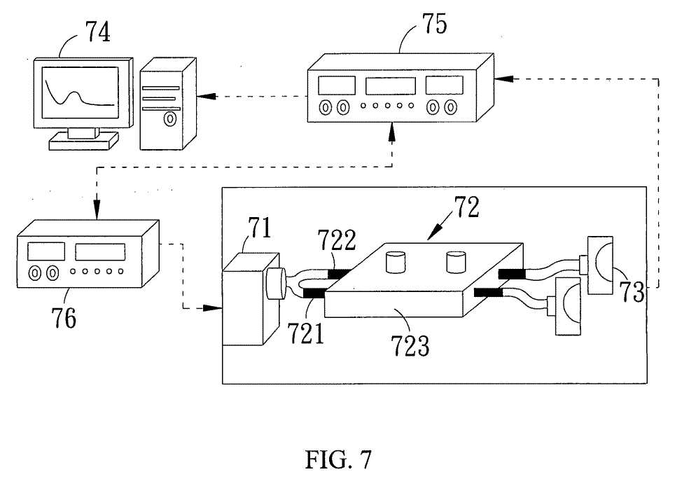

Refer now to FIG. 7, wherein a diagram for a self-referencing fiber-optic localized plasmon resonance sensing system according to the present invention is shown. The illustrated self-referencing fiber-optic localized plasmon resonance sensing system comprises: a light source 71, a fiber-optic localized plasmon resonance sensing device 72 and a photo detecting unit 73. The light source 71 may be a Light Emitting Diode (LED) for generation of the incident light, wherein the incident light is coupled into the fiber-optic localized plasma resonance sensing device 72 via a fiber-optic coupler. The fiber-optic localized plasmon resonance sensing device 72 comprises a reference optical fiber 721, a sensing optical fiber 722 and a carrier 723. The reference optical fiber 721 is modified with a first noble metal nanoparticle layer, and receives the incident light to generate a first localized plasmon resonance sensor signal. The sensing optical fiber 722 is modified with a second noble metal nanoparticle layer, wherein the second noble metal nanoparticle layer is further modified with a recognition unit, and receives the incident light to generate a second localized plasmon resonance sensor signal. The carrier 723 is used for placement of the reference optical fiber 721 and the sensing optical fiber 722. The photo detecting unit 73 may be a photodiode for receiving the first localized plasmon resonance sensor signal and the second localized plasmon resonance sensor signal. A processing unit 74 is allowed to perform referencing on the second localized plasmon resonance sensor signal based on the first localized plasmon resonance sensor signal. The fiber-optic localized plasmon resonance sensing system further comprises a lock-in amplifier 75 and a signal generator 76, in which the lock-in amplifier 75 enables amplification of the first localized plasmon resonance sensor signal and the second localized plasmon resonance sensor signal as well as suppression of system noises, and the signal generator 76 drives the light source to generate and regulate the incident light, and also provides the lock-in amplifier with a reference signal.

During detection of biological or chemical samples, it is possible to employ the selectivity of the recognition unit for sensing operations at various concentrations, in which the sensing optical fiber 722 is modified with a recognition unit, while the reference optical fiber 721 is not. The dielectric environment within the vicinity of the sensing fiber-optic 722 varies as the recognition unit on the surface of the noble metal nanoparticles and the target interacts, thereby decreasing the second localized plasmon resonance sensor signal and the generated temporal signal presents a molecular binding kinetic curve. Since the surface of the reference optical fiber 721 is not modified with the recognition unit, the variations in the first localized plasmon resonance sensor signal simply result from changes in the refraction index of the sample, nonspecific absorptions or other environmental factors. The first localized plasmon resonance sensor signal can be the signal I_{R0}, which is obtained upon detecting a blank and the nanoparticle surface of the reference optical fiber 721 not modified with a recognition unit, and the signal I_{R}, which is obtained upon detecting a sample of different concentrations of a target by means the reference optical fiber 721; the second localized plasmon resonance sensor signal can be the signal I_{S0}, which is obtained upon detecting the blank and the nanoparticle surface of the sensing optical fiber 722 modified with the recognition unit, and the signal I_{S}, which is obtained upon detecting the sample by means the sensing optical fiber 722. Please refer to the following equations:

I′₀=I_{S0}/I_{R0}

I′=I_{S}/I_{R}

T′=I′/I′₀=(I_{S}/I_{R})/(I_{S0}/I_{R0})=(I_{S}/I_{S0})/(I_{R}/I_{R0})=T_{S}/T_{R}

The parameters used in the aforementioned equations are respectively illustrated as below: I′₀ indicates the corrected signal obtained by the division of the above-said I_{S0} by I_{R0} when detecting the same blank; I′ is the corrected signal obtained by the division of the above-said I_{S} by I_{R} when detecting the same sample; and T′=I′/I′₀ represents the relative signal obtained after self-referencing. After taking the -log value on the concentration of the target as the x-axis, then plotting with respect to T′=I′/I′₀ as the y-axis, the linear part of the plot between the relative signal and the -log concentration can be used as a calibration graph.

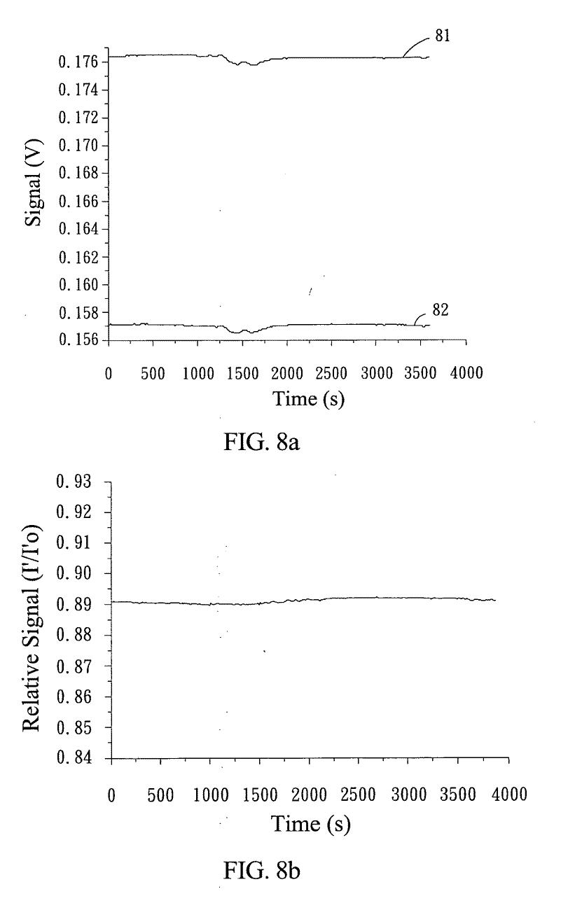

Refer subsequently to FIG. 8a, wherein a diagram for the signal-time relationships obtained by a first embodiment of the self-referencing fiber-optic localized plasmon resonance system according to the present invention is shown. Refer also to FIG. 8b, wherein a diagram for the relative signal-time relationship obtained by the first embodiment of the self-referencing fiber-optic localized plasmon resonance system according to the present invention is shown. Due to the sensitivity of the localized plasmon resonance to ambient temperature, the self-referencing fiber-optic localized plasmon resonance sensing system according to the present invention simultaneously performs respective tests on the reference optical fiber 81 and the sensing optical fiber 82 at different temperatures in order to examine the effect on self-correction of temperature fluctuation through the self-referencing operations. In general, the refractive index of a solution relates to temperature; as a result, the signal decreases as temperature arises and vice versa. In the self-referencing fiber-optic localized plasmon resonance sensing system, when temperature increases, the signals in both the reference optical fiber and the sensing optical fiber drop at the same time; while when temperature decreases, however, the signals rise up together; accordingly a relatively flat signal can be seen on the signal versus time diagram acquired after self-referencing by using the relative signal (I′/I′₀).

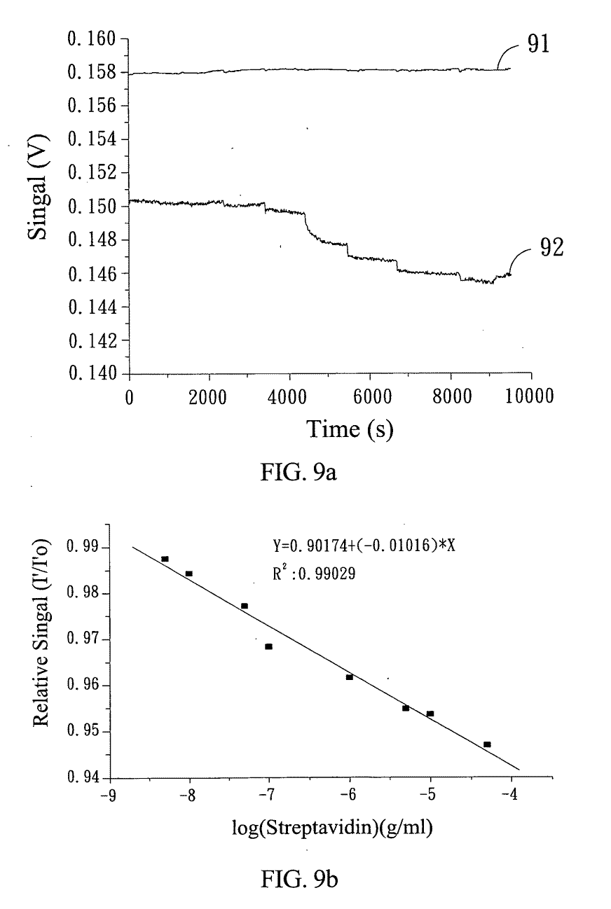

Refer to FIG. 9a, wherein a diagram of the signal-time relationships obtained by a second embodiment of the self-referencing fiber-optic localized plasmon resonance system according to the present invention is shown. Also refer to FIG. 9b, wherein a diagram for the relative signal-logarithm concentration obtained by the second embodiment of the self-referencing fiber-optic localized plasmon resonance system according to the present invention is shown. In order to substantiate the qualitative and quantitative feasibilities for application of the present system, an experiment to detect streptavidin of different concentrations with vitamin H (biotin) as the recognition unit is designed. From the results of the experiment it can be observed that, upon injection of streptavidin at a high concentration, no significant change in signal from the reference optical fiber 91 is shown, essentially because the hydrophility of the hydroxyl end group (—OH) on the surface of the noble metal particles resist nonspecific surface adsorption; meanwhile, when the sensing optical fiber 92 is functionalized with biotin, and upon binding between biotin and streptavidin, a decrease in the signal can be observed (as shown in FIG. 9a), and the temporal signal thus generated present a molecular binding kinetic curve. With the above-illustrated results, by means of sequentially injecting streptavidin of different concentrations for tests, the plot of signal versus log concentration has a correlation coefficient of 0.990 (as shown in FIG. 9b), which is close to the value of 0.996 obtained from the non self-referencing single fiber-optic sensing system, and the plot also yields a detection limit of 3.8×10⁻¹¹M, which is also similar to the value of 4.1×10⁻¹¹ M deduced from the non self-referencing single fiber-optic sensing system.

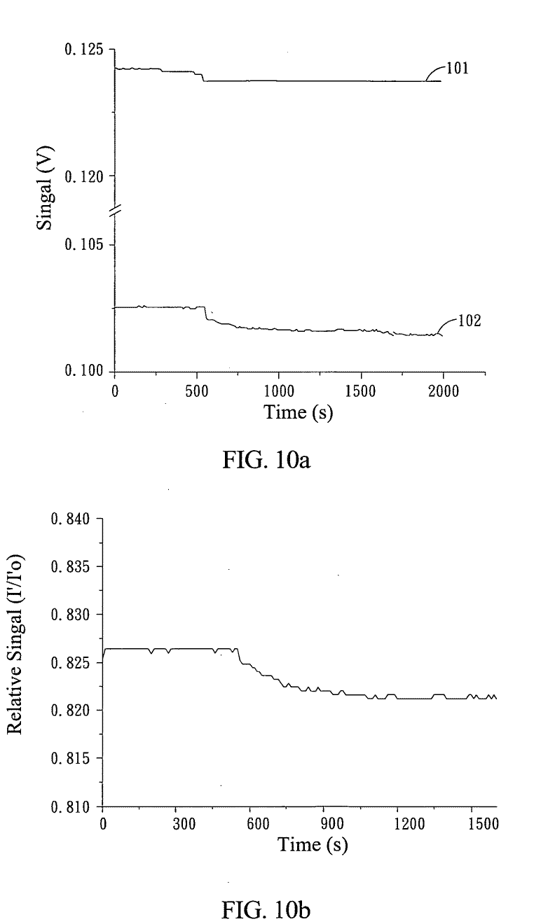

With reference to FIG. 10a, a diagram for the signal-time relationships obtained by a third embodiment of the self-referencing fiber-optic localized plasmon resonance system according to the present invention is shown. Refer to FIG. 10b as well, wherein a diagram for the relative signal-time relationship obtained by the third embodiment of the self-referencing fiber-optic localized plasmon resonance system according to the present invention is illustrated. During detection, samples of high viscosity may lead to changes of the refractive index of the solutions, thus resulting in errors during detection. For example, detection of the IL-1β content in the knee synovial fluid of a patient with osteoarthritis (OA) is provided, in which, after sample preparation processes, the sample of synovial fluid still presents comparatively high viscosity. However, by means of the self-referencing sensing system according to the present invention, excessive dilution steps can be avoided for performing the detection, thereby facilitating improvement on the detection limit.

Using a solution of MUA/MCH mixture, it is possible to perform the self-assembly of a mixed monolayer film on the surface of gold nanoparticles. The method of forming the probe includes the steps of, initially, activating the carboxyl end group of MUA, and then conjugating it with an anti-human IL-1β antibody through chemical reactions. In a conventional single fiber-optic sensing system, when detecting a real synovial fluid sample, it is required to dilute the highly viscous sample beforehand, but errors may be so introduced during dilution, causing inaccuracy and unnecessary time cost, and also degrades the detection limit of the method.

However, using the self-referencing localized plasmon resonance sensing system according to the present invention for detection of the real synovial fluid samples, it is possible to start the tests by just slightly diluting the viscous synovial fluid. Since the ultimate goal of the present system is to determine the IL-1β content in the knee synovial fluid of an OA patient, it can be seen that the introduction of a viscous sample causes an initial sharp drop in signals for signals from both the reference optical fiber and the sensing optical fiber (as shown in FIG. 10a), such sharp signal drops are errors and lead to inaccuracy. After self-correction by the self-referencing localized plasmon resonance sensing system, a characteristic molecular binding kinetic curve without the initial sharp drop in signal can be observed (as shown in FIG. 10b), and the measured concentration of IL-1β in the sample is 1.72×10⁻¹⁰ M, which is close to the result obtained by the single fiber-optic sensing system, but excessive dilution is no longer required.

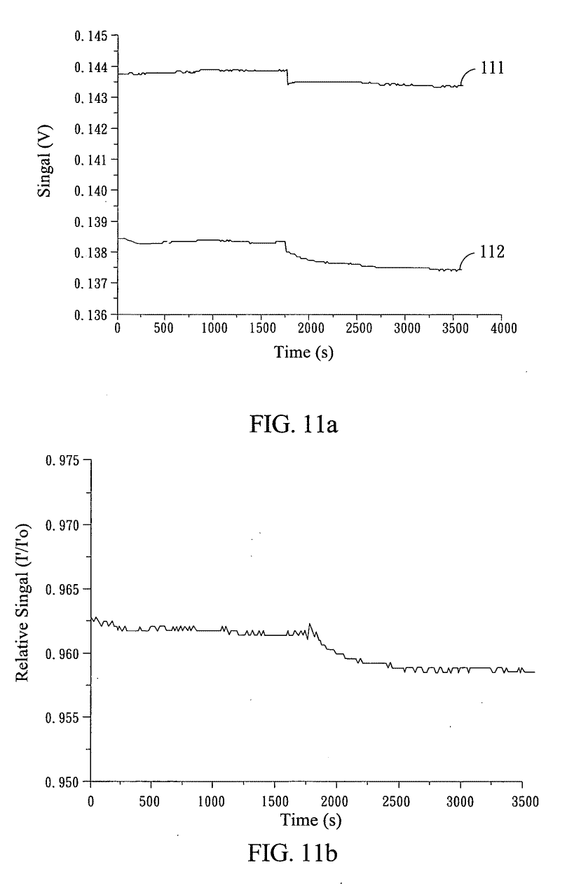

In the following texts, reference is made to FIG. 11a, wherein a diagram for the signal-time relationships obtained by a fourth embodiment of the self-referencing fiber-optic localized plasmon resonance system according to the present invention is shown. Also, refer to FIG. 11b, wherein a diagram for the relative signal-time relationship in the fourth embodiment of the self-referencing fiber-optic localized plasmon resonance system according to the present invention is shown. When a real sample presents a certain color, spectral interference may occur, leading to an error in the analysis. In an experiment using the sap containing CymMV orchid virus, the color of diluted orchid sap is still greenish (absorption band thereof located at about 600 nm), which may cause spectral interference and refractive index difference of the solution as compared to a blank. Upon injecting the sap containing the CymMV virus, since the reference optical fiber is only modified with MCH without the antibody specific for the virus, it can be seen from FIG. 11a that an initial sharp drop in the signal from the reference optical fiber 111, essentially due to the spectral interference and change in refractive index; whereas, the sensing optical fiber 112 is modified on the antibody specific for the virus, thus after the initial sharp drop in the signal, there presents a molecular binding kinetic curve, because of the interaction between the antibody and the virus. With self-correction of signals using signals from both the reference optical fiber 111 and the sensing optical fiber 112 (I′/I′₀), it can be clearly seen that the acquired data by self-referencing sensing system as shown in FIG. 11b provides a corrected feature of merely the molecular binding kinetic curve thereby reducing the spectral interference occurring when the sample presents a color.

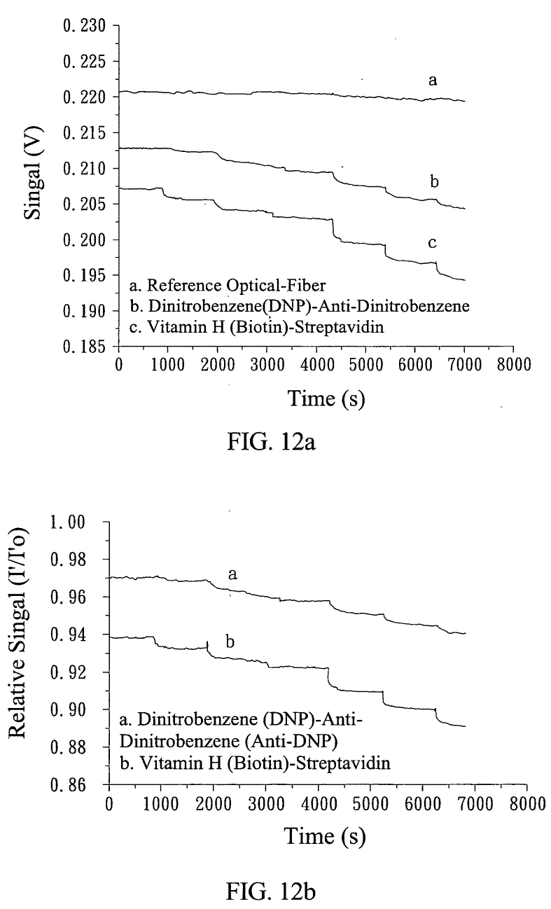

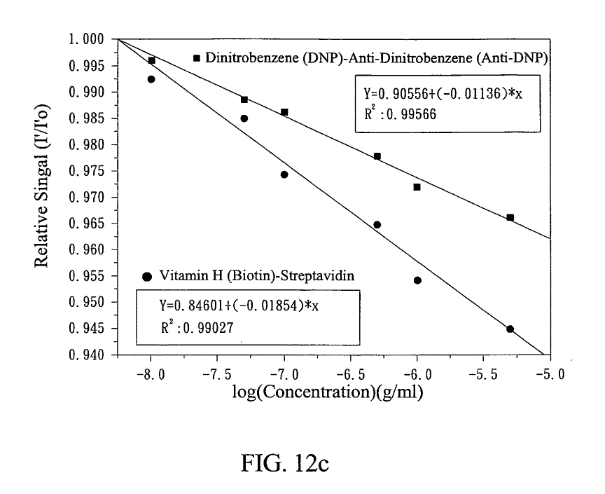

Refer next to FIG. 12a, wherein a diagram for the signal-time relationships obtained by a fifth embodiment of the self-referencing fiber-optic localized plasmon resonance system according to the present invention is shown. Refer subsequently to FIG. 12b, wherein a diagram for the relative signal-time relationship in the fifth embodiment of the self-referencing fiber-optic localized plasmon resonance system according to the present invention. Additionally, refer also to FIG. 12c, wherein a diagram for the relative signal-logarithm concentration relationships in the fifth embodiment of the self-referencing fiber-optic localized plasmon resonance system according to the present invention is shown. Typically, several biochemical species of interest may coexist in a real sample. In order to achieve simultaneous detection of these biochemical species, a component for multiplex detection is designed which is configured with a reference optical fiber without any recognition unit and a plurality of sensing optical fibers modified with one recognition unit for one of the biochemical species on each sensing fiber, thereby allowing simultaneous multiplex detection by using self-referencing.

One experiment for multiplex detection by means of the self-referencing fiber-optic localized plasmon resonance sensing system is to detect the solutions consisting of both streptavidin and anti-dinitrophenyl antibody (anti-DNP) having different concentrations of streptavidin and anti-DNP, and perform self-referencing based on the reference optical fiber in order to achieve multiplex detection. FIG. 12a shows a diagram for the signal-time relationships from the reference fiber and the sensing fibers. It can be seen that the molecular binding kinetic curves for detection of streptavidin by the biotin-functionalized optical fiber and detection of anti-DNP by the DNP-functionalized optical fiber at different concentrations are observed. With self-correction of signals using signals from the reference optical fiber 111 and the sensing optical fibers, it can be seen that as the concentration of the targets increases, the characteristic molecular binding kinetic curves and linear calibration graphs are still observed, which substantiates the feasibility of the self-referencing simultaneous multiplex detection, as shown in FIGS. 12b and 12c.

The descriptions set forth hereinbefore are simply exemplary rather than being restrictive. All effectively equivalent modifications, changes or alternations made thereto without departing from the spirit and scope of the present invention are deemed as being encompassed by the field of the present invention defined as the following claims.

What is claimed is:

1. A self-referencing fiber-optic localized plasmon resonance sensing device, comprising:
a reference optical fiber being modified with a first noble metal nanoparticle layer, and the reference optical fiber receiving an incident light to generate a first localized plasmon resonance sensor signal;
at least one sensing optical fiber being modified with a second noble metal nanoparticle layer, the second noble metal nanoparticle layer being further modified with a recognition unit, and the sensing optical fiber receiving the incident light to generate a second localized plasmon resonance sensor signal; and
a carrier being arranged for placement of the reference optical fiber and the sensing optical fiber;
wherein a processing unit is allowed to perform referencing on the second localized plasmon resonance sensor signal based on the first localized plasmon resonance sensor signal.

2. The self-referencing fiber-optic localized plasmon resonance sensing device according to claim 1, wherein the first localized plasmon resonance sensor signal are a signal I_{R0} obtained upon detecting a blank and with the surface of the noble metal nanoparticles not modified with a recognition unit, and a signal I_{R} obtained upon detecting a sample by means of the reference optical fiber, wherein the second localized plasmon resonance sensor signal are a signal I_{S0} obtained upon detecting the blank and with the surface of the noble metal nanoparticles modified with a recognition unit, and a signal I_{S} obtained upon detecting the sample by means of the sensing optical fiber, wherein the first localized plasmon resonance sensor signal and the second localized plasmon resonance sensor signal are expressed by the following equations:
I′₀=I_{S0}/I_{R0};
I′=I_{S}/I_{R};
T′=I′/I′₀=(I_{S}/I_{R})/(I_{S0}/I_{R0})=(I_{S}/I_{S0})/(I_{R}/I_{R0})=T_{S}/T_{R};
wherein I′₀ indicates a corrected signal obtained by the division of the above-said I_{S0} by I_{R0} when detecting the blank; I′ is a corrected signal obtained by the division of the above-said I_{S} by I_{R} when detecting the sample and T′=I′/I′₀ represents the relative signal obtained after self-referencing.

3. The self-referencing fiber-optic localized plasmon resonance sensing device according to claim 1, wherein the first noble metal nanoparticle layer is modified at a stripped area or an end face of the reference optical fiber.

4. The self-referencing fiber-optic localized plasmon resonance sensing device according to claim 1, wherein the second noble metal nanoparticle layer is modified at a stripped area or an end face of the sensing optical fiber.

5. The self-referencing fiber-optic localized plasmon resonance sensing device according to claim 1, wherein the fiber-optic localized plasmon resonance sensing device is a micro fluidic chip or an in-situ sampling and analysis device.

6. The self-referencing fiber-optic localized plasmon resonance sensing device according to claim 5, wherein the fiber-optic localized plasmon resonance sensing device is the in-situ sampling and analysis device, the reference optical fiber and the sensing optical fiber are respectively constructed with a mirror at one end face of the sensing optical fiber and at one end face of the reference optical fiber.

7. The self-referencing fiber-optic localized plasmon resonance sensing device according to claim 6, wherein the reference optical fiber and the sensing optical fiber are further disposed with a filter membrane and a rigid holder with at least one opening, the mirrors are provided for reflecting the first localized plasmon resonance sensor signal and the second localized plasmon resonance sensor signal, the filter membrane sieves out interfering substances with sizes larger than that of the average pore size of the membrane, and the rigid holder encases the reference optical fiber the sensing optical fiber in order to enhance the mechanical strength of the device during the sampling operation.

8. The self-referencing fiber-optic localized plasmon resonance sensing device according to claim 1, wherein the referencing includes compensations for interferences caused by the refractive index variations in the sample due to fluctuations in ambient temperature or changes in the composition of the sample, color of the sample, undesirable vibrations or signal deviations resulted from unstable light source.

9. The self-referencing fiber-optic localized plasmon resonance sensing device according to claim 1, wherein the recognition unit comprises a chemical recognition molecule, an antibody, an antigen, a lectin, a hormone receptor, a nucleic acid or a carbohydrate.

10. A self-referencing fiber-optic localized plasmon resonance sensing system, comprising:
a light source generating an incident light;
a fiber-optic localized plasmon resonance sensing device, comprising:
a reference optical fiber being modified with a first noble metal nanoparticle layer, and the reference optical fiber receiving the incident light to generate a first localized plasmon resonance sensor signal;
at least one sensing optical fiber being modified with a second noble metal nanoparticle layer, the second noble metal nanoparticle layer being further modified with a recognition unit, and the sensing optical fiber receiving the incident light to generate a second localized plasmon resonance sensor signal; and
a carrier being arranged for placement of the reference optical fiber and the sensing optical fiber;
a photo detecting unit receiving the first localized plasmon resonance sensor signal and the second localized plasmon resonance sensor signal; and
a processing unit performing referencing on the second localized plasmon resonance sensor signal based on the first localized plasmon resonance sensor signal.

11. The self-referencing fiber-optic localized plasmon resonance sensing system according to claim 10, wherein the first localized plasmon resonance sensor signal are a signal I_{R0} obtained upon detecting a blank and with the surface of the noble metal nanoparticles not modified with a recognition unit, and a signal I_{R} obtained upon detecting a sample by means of the reference optical fiber, wherein the second localized plasmon resonance sensor signal are a signal I_{S0} obtained upon detecting the blank and with the surface of the noble metal nanoparticles modified with a recognition unit, and a signal I_{S} obtained upon detecting the sample by means of the sensing fiber-optic, wherein the first localized plasmon resonance sensor signal and the second localized plasmon resonance sensor signal are expressed by the following equations:
I′₀=I_{S0}/I_{R0};
I′=I_{S}/I_{R};
T′=I′/I′₀=(I_{S}/I_{R})/(I_{S0}/I_{R0})=(I_{S}/I_{S0})/(I_{R}/I_{R0})=T_{S}/T_{R};
wherein I′₀ indicates a corrected signal obtained by the division of the above-said I_{S0} by I_{R0} when detecting the blank, and I′ is a corrected signal obtained by the division of the above-said I_{S} by I_{R} when detecting the sample; and T′=I′/I′₀ represents the relative signal obtained after self-referencing.

12. The self-referencing fiber-optic localized plasmon resonance sensing system according to claim 10, wherein the first noble metal nanoparticle layer is modified at a stripped area or an end face of the reference optical fiber.

13. The self-referencing fiber-optic localized plasmon resonance sensing system according to claim 10, wherein the second noble metal nanoparticle layer is modified at a stripped area or an end face of the sensing optical fiber.

14. The self-referencing fiber-optic localized plasmon resonance sensing system according to claim 10, wherein the fiber-optic localized plasmon resonance sensing device is a micro fluidic chip or an in-situ sampling and analysis device.

15. The self-referencing fiber-optic localized plasmon resonance sensing system according to claim 14, wherein the fiber-optic localized plasmon resonance sensing device is the in-situ sampling and analysis device, the reference optical fiber and the sensing optical fiber are respectively constructed with a mirror at one end face of the sensing optical fibers and at one end face of the reference optical fiber.

16. The self-referencing fiber-optic localized plasmon resonance sensing system according to claim 15, wherein the reference optical fiber and the sensing optical fiber are further disposed with a filter membrane and a rigid holder with at least one opening, the mirrors are provided for reflecting the first localized plasmon resonance sensor signal and the second localized plasmon resonance sensor signal, the filter membrane sieves out interfering substances with sizes larger than that of the average pore size of the membrane, and the rigid holder encases the reference optical fiber the sensing optical fiber in order to enhance the mechanical strength of the device during the sampling operation.

17. The self-referencing fiber-optic localized plasmon resonance sensing system according to claim 10, wherein the referencing includes compensations for interferences caused by the refractive index variations in the sample due to fluctuations in ambient temperature or changes in the composition of the sample, color of the sample, undesirable vibrations or signal deviations resulted from unstable light source.

18. The self-referencing fiber-optic localized plasmon resonance sensing system according to claim 10, wherein the recognition unit comprises a chemical recognition molecule, an antibody, an antigen, a lectin, a hormone receptor, a nucleic acid or a carbohydrate.

19. The self-referencing fiber-optic localized plasmon resonance sensing system according to claim 10, further comprising a lock-in amplifier enabling amplification of the first localized plasmon resonance sensor signal and the second localized plasmon resonance sensor signal as well as suppression of system noises.
